(19) United States
(12) Patent Application Publication
(10) Pub. No.: US 2013/0269663 A1
(43) Pub. Date: Oct. 17, 2013

(54) EXHAUST-GAS HEAT EXCHANGE DEVICE

(71) Applicants: Kouki Nishiyama, Kariya-city (JP); Haruhiko Watanabe, Mie-gun (JP); Takayuki Hayashi, Nagoya-city (JP)

(72) Inventors: Kouki Nishiyama, Kariya-city (JP); Haruhiko Watanabe, Mie-gun (JP); Takayuki Hayashi, Nagoya-city (JP)

(73) Assignee: DENSO CORPORATION, Kariya-city, Aichi-pref. (JP)

(21) Appl. No.: 13/996,424

(22) PCT Filed: Dec. 20, 2011
(86) PCT No.: PCT/JP2011/007101

§ 371 Date: Jun. 20, 2013

(30) Foreign Application Priority Data
Dec. 22, 2010 (JP) 2010-286472

(51) Int. Cl. F02M 25/07

(52) U.S. Cl. CPC F02M 25/07
USPC 123/568.12

(57) ABSTRACT

An exhaust-gas heat exchange device includes an inflow portion, a first outflow portion, a second outflow portion and a flow-rate adjustment portion. The inflow portion is provided on one end side of a casing that a cooling medium flows into a cooling medium passage. The first outflow portion is provided on the other end side of the casing so that the cooling medium flows out of the cooling medium passage. Moreover, the second outflow portion is provided on the one side of the cooling medium passage and at a position opposed to the inflow portion. The flow-rate adjustment portion is provided so as to generally allow the cooling medium to flow out through the first outflow portion and of the second outflow portion, and to adjust a ratio of flow rates of the cooling medium flowing out through the first outflow portion and the second outflow portion.

### CROSS REFERENCE TO RELATED APPLICATION

This application is based on and incorporates herein by reference Japanese Patent Application No. 2010-286472 filed on Dec. 22, 2010.

### TECHNICAL FIELD

The present invention relates to an exhaust-gas heat exchange device which cools exhaust gas for an exhaust-gas recirculation device (EGR).

### BACKGROUND ART

A conventional exhaust-gas heat exchange device shown, for example, in Patent Document 1 (EGR-gas cooling control device) is known. That is, in the exhaust-gas heat exchange device of Patent Document 1, an EGR cooler is disposed in an EGR pipe which causes exhaust gas of an engine to flow back to intake air, and heat exchange is performed in the EGR cooler between the exhaust gas and engine coolant so that the exhaust gas is cooled.

The EGR cooler is a so-called shell-and-tube heat exchanger formed of multiple EGR-gas passages (tubes) through which the exhaust gas flows, and a coolant passage (shell) accommodating these EGR-gas passages therein. Coolant pipes of the engine are connected to the coolant passage on one side and the other side of the coolant passage in its longitudinal direction so as to be located at positions diagonally opposed to each other. A coolant inlet portion and a coolant outlet portion are formed in the coolant passage, and the engine coolant flows on an outer side of the multiple EGR-gas passages inside the coolant passage.

Moreover, a coolant valve is provided along the coolant pipe, and a flow rate of the engine coolant flowing through the coolant passage of the EGR cooler is regulated by adjusting an open degree of the valve, so that a cooling capacity of the EGR cooler is controlled.

In Patent Document 1, a target open degree of the coolant valve is set based on a throttle open degree and an engine speed, and a coolant flow rate dependent on a required cooling capacity of the EGR cooler is set. Thus, the EGR gas is cooled appropriately, and is prevented from supercooling.

Furthermore, when an operating condition of the engine is changed from a normal running operating condition to an idle operating condition, the cooling capacity of the EGR cooler is adjusted so as to be kept larger than a target cooling capacity required in the idle operating condition until a predetermined time elapses. Accordingly, it can be avoided that a flow rate of coolant supplied to the EGR cooler in the idle operating condition dramatically decreases from a coolant flow rate of the normal running operating condition, and thus boiling of the engine coolant can be prevented. In Patent Document 1, the operating condition of the engine is determined based on the engine speed or the throttle open degree, and the boiling of the engine coolant is prevented at low cost without providing, for example, an additional sensor.

### PRIOR ART DOCUMENT

### Patent Document

Patent Document 1: JP 2005-344591 A

However, in the EGR cooler of Patent Document 1, since the coolant inlet portion and the coolant outlet portion are arranged at daiagonal positions of the coolant passage, coolant inflowing through the inlet portion is easy to flow toward the outlet portion in a diagonal direction. Thus, a dead flow zone is easily formed at a position opposed to the inlet portion in the coolant passage, and local boiling of the coolant in the dead flow zone may be generated easily.

### SUMMARY OF THE INVENTION

In consideration of the above-described points, it is an objective of the present disclosure to provide an exhaust-gas heat exchange device that restricts boiling of coolant in a dead flow zone while preventing supercooling of exhaust gas.

To achieve the above-described objective, according to a first aspect of the present disclosure, an exhaust-gas heat exchange device includes an exhaust gas passage, a casing, an inflow portion, a first outflow portion, a second outflow portion and a flow-rate adjustment portion. Exhaust gas discharged from an internal combustion engine flows through the exhaust gas passage. The casing is provided to cover the exhaust gas passage and has a cooling medium passage through which a cooling medium flows between an inner wall of the casing and an outer wall of the exhaust gas passage. The cooling medium flows into the cooling medium passage through the inflow portion, and the inflow portion is provided on one end side of the casing that extends along the exhaust gas passage. The cooling medium flows out of the cooling medium passage through the first outflow portion, and the first outflow portion is provided on the other end side of the casing that extends along the exhaust gas passage. The cooling medium flows out of the cooling medium passage through the second outflow portion, and the second outflow portion is provided on the one end side of the casing that extends along the exhaust gas passage and at a position opposed to the inflow portion. A downstream side of the second outflow portion joins a downstream side of the first outflow portion. The flow-rate adjustment portion generally allows the cooling medium to flow out through the first outflow portion and the second outflow portion, and adjusts a ratio between flow rates of the cooling medium flowing out through the first outflow portion and the second outflow portion.

Hence, the ratio between flow rates of cooling medium flowing out through the first outflow portion and the second outflow portion is adjusted by the flow-rate adjustment portion depending on an operating condition of the internal combustion engine. For example, when a ratio of the flow rate of cooling medium flowing out through the first outlet portion is reduced, a flow rate of cooling medium flowing from the inflow portion toward the first outflow portion can be reduced. Accordingly, a heat exchange amount between the exhaust gas and the cooling medium can be reduced purposely. When an operating load of the internal combustion engine is low, supercooling of the exhaust gas can be prevented by reducing the heat exchange amount.

Moreover, the second outflow portion is provided at the position opposed to the inflow portion. When a ratio of the flow rate of cooling medium flowing out through the second outlet portion is increased, a flow rate of cooling medium flowing from the inlet portion directly to the second outflow portion can be increased. A dead flow zone can be prevented from being generated, and local boiling of the cooling medium can be prevented.

Moreover, the flow adjustment portion generally allows the cooling medium to flow out through the first outflow portion and the second outflow portion. When the cooling medium flows out mainly through the first outflow portion while flowing out partially through the second outflow portion, local boiling of the cooling medium can be prevented. When the cooling medium flows out mainly through the second outflow portion while flowing out partially through the first outflow portion, a basic capacity to cool the EGR gas with the cooling medium can be ensured.

According to a second aspect of the present disclosure, the flow-rate adjustment portion may set the flow rate of the cooling medium flowing out through the first outflow portion higher than the flow rate of the cooling medium flowing out through the second outflow portion depending on an operating condition of the internal combustion engine when a heat amount of the exhaust gas is larger than a predetermined heat amount. The flow-rate adjustment portion may set the flow rate of the cooling medium flowing out through the second outflow portion higher than the flow rate of the cooling medium flowing out through the first outflow portion when the heat amount of the exhaust gas is smaller than the predetermined heat amount.

In this case, when the heat amount of the exhaust gas is larger than the predetermined heat amount, the flow-rate adjustment portion sets the flow rate of the cooling medium flowing out through the first outflow portion higher than the flow rate of the cooling medium flowing out through the second outflow portion. Since a flow rate of cooling medium flowing from the inflow portion toward the first outflow portion can be increased depending on the heat amount of the exhaust gas in the cooling medium passage, heat exchange between the exhaust gas and the cooling medium can be performed surely, and a temperature of the exhaust gas can be decreased appropriately.

On the other hand, when the heat amount of the exhaust gas is smaller than the predetermined heat amount, the flow-rate adjustment portion sets the flow rate of the cooling medium flowing out through the second outflow portion higher than the flow rate of the cooling medium flowing out through the first outflow portion. Since a flow rate of cooling medium flowing from the inflow portion toward the first outflow portion can be reduced in the cooling medium passage, heat exchange between the exhaust gas and the cooling medium can be limited, and supercooling of the exhaust gas can be prevented. Moreover, since a flow rate of cooling medium flowing from the inflow portion directly to the second outflow portion can be increased, generation of a dead flow zone can be prevented, and local boiling of the cooling medium can be prevented.

According to a third aspect of the present disclosure, the flow-rate adjustment portion may be a thermostat, which adjusts an open degree of a valve element that is provided on at least one of the downstream side of the first outflow portion or the downstream side of the second outflow portion, depending on a temperature of the cooling medium. The temperature of the cooling medium changes based on the heat amount of the exhaust gas. In this case, the open degree of the valve element is automatically adjusted depending on the temperature of the cooling medium, and thus flow-rate adjustment can be performed easily and at low cast without requiring a special control device.

According to a fourth aspect of the present disclosure, the thermostat may adjust the open degree of the valve element depending on a temperature of the cooling medium flowing through the second outflow portion. In this case, cooling medium, which has exchanged heat with the exhaust gas in the cooling medium passage, flows out through the second outflow portion earlier than flowing through the first outflow portion. Because the open degree of the valve element is adjusted depending on the temperature of the cooling medium flowing through the second outflow portion, rapid-response flow-rate adjustment becomes possible.

According to a fifth aspect of the present disclosure, the flow-rate adjustment portion may be an electric valve which opens or closes at least one of the first outflow portion or the second outflow portion by an external electric signal corresponding to at least one of a temperature of the cooling medium or a temperature of the exhaust gas that changes depending on the heat amount of the exhaust gas. In this case, correct flow-rate adjustment corresponding to at least one of the temperature of the cooling medium or the temperature of the exhaust gas is possible.

### BRIEF DESCRIPTION OF THE DRAWINGS

The above-described or additional objectives, features and advantages of the present invention will be more obvious from the following description, referring to the drawings described below.

FIG. 1 is a schematic diagram showing an exhaust-gas recirculation device (EGR) using an EGR-gas cooling device according to a first embodiment.

FIG. 2 is a schematic sectional diagram showing the EGR-gas cooling device.

FIG. 3 is a schematic sectional diagram showing a valve open state 1 of a thermostat.

FIG. 4 is a schematic sectional diagram showing a flow of coolant in the EGR-gas cooling device in FIG. 3.

FIG. 5 is a schematic sectional diagram showing a valve open state 2 of the thermostat.

FIG. 6 is a schematic sectional diagram showing a flow of coolant in the EGR-gas cooling device in FIG. 5.

FIG. 7 is a schematic sectional diagram showing a valve open state 1 of a thermostat according to a second embodiment.

FIG. 8 is a schematic sectional diagram showing a valve open state 2 of the thermostat according to the second embodiment.

FIG. 9 is a schematic sectional diagram showing an EGR-gas cooling device according to a third embodiment.

FIG. 10 is a flowchart showing a control state of an electromagnetic valve in FIG. 9.

FIG. 11 is a schematic sectional diagram showing an EGR-gas cooling device according to a fourth embodiment.

FIG. 12 is a schematic sectional diagram showing an EGR-gas cooling device according to a fifth embodiment.

FIG. 13 is a schematic sectional diagram showing an EGR-gas cooling device according to a sixth embodiment.

### EMBODIMENTS FOR EXPLOITATION OF THE INVENTION

Hereinafter, multiple embodiments for implementing the present invention will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

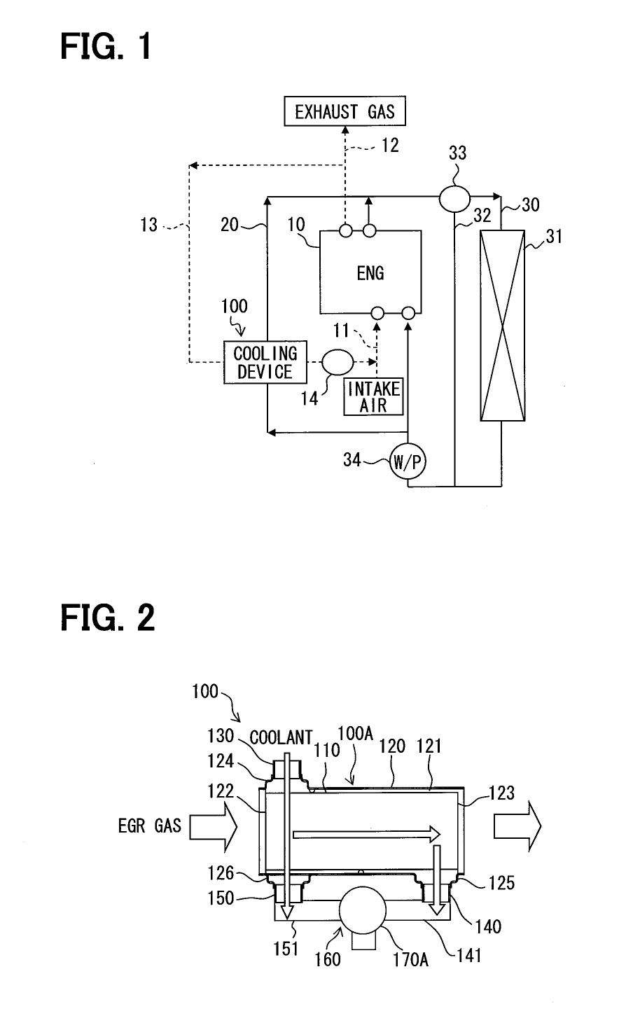

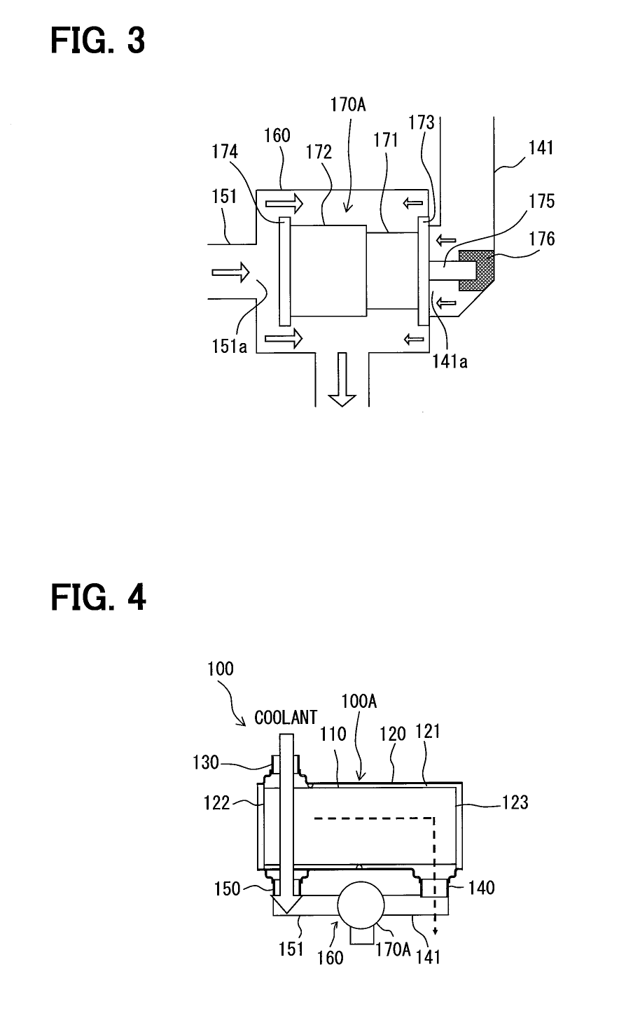

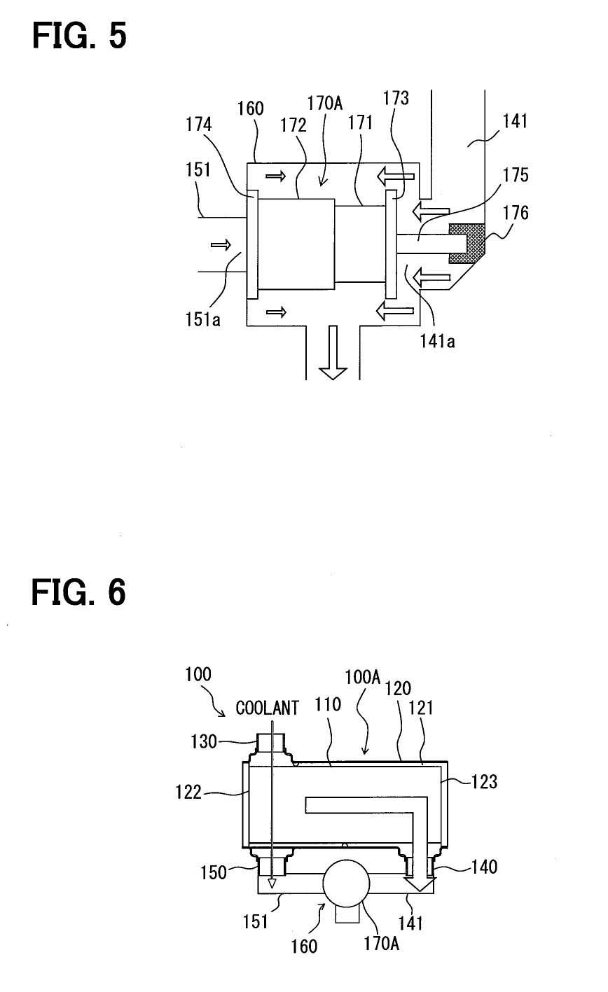

In the present embodiment, an exhaust-gas heat exchange device according to the present disclosure is applied to an EGR-gas cooling device 100 for a diesel engine 10. FIG. 1 is a schematic diagram showing an exhaust-gas recirculation device (EGR) using the EGR-gas cooling device 100 according to the present embodiment, FIG. 2 is a schematic sectional diagram showing the EGR-gas cooling device 100, FIG. 3 is a schematic sectional diagram showing a valve open state 1 of a thermostat 170A, FIG. 4 is a schematic sectional diagram showing a flow of coolant in the EGR-gas cooling device 100 in FIG. 3, FIG. 5 is a schematic sectional diagram showing a valve open state 2 of the thermostat 170A, and FIG. 6 is a schematic sectional diagram showing a flow of coolant in the EGR-gas cooling device 100 in FIG. 5.

As shown in FIG. 1, the EGR is provided in the engine 10 that is used as an internal combustion engine of a vehicle, and the EGR is a device for reducing nitrogen oxide in exhaust gas and includes an exhaust-gas recirculation pipe 13, an EGR valve 14, an EGR coolant circuit 20 and the EGR-gas cooling device 100. The exhaust-gas recirculation pipe 13 is a pipe connecting a middle part of an intake air pipe 11 of the engine 10 and a middle part of an exhaust gas pipe 12, and causes a part of exhaust gas which is discharged from the engine 10 and is flowing through the exhaust gas pipe 12 to flow back to the intake pipe 11 of the engine 10. The EGR valve 14 is disposed in a middle part of the exhaust-gas recirculation pipe 13 in an exhaust-gas flow direction, and adjusts a flow rate of exhaust gas (EGR gas) flowing through the exhaust-gas recirculation pipe 13 depending on an operating condition of the engine 10.

The EGR coolant circuit 20 is, in a radiator circuit 30 described later, a circuit formed so as to be branched from a downstream side of a water pump 34 in a coolant flow and be joined to an upstream side of a thermostat 33, and the water pump 34 causes a part of coolant of the engine 10 circulating in the radiator circuit 30 to flow in directions of arrows in FIG. 1. The coolant of the engine 10 corresponds to cooling medium of the present invention.

The EGR-gas cooling device 100 is an exhaust-gas heat exchange device which cools EGR gas by performing heat exchange between the EGR gas (exhaust gas) and the coolant of the engine 10. The EGR-gas cooling device 100 is disposed between the exhaust gas pipe 12 and the EGR valve 14 in the exhaust-gas recirculation pipe 13. EGR gas flowing through the exhaust-gas recirculation pipe 13 and coolant flowing through the EGR coolant circuit 20 are supplied to the EGR-gas cooing device 100.

The engine 10 is provided with the radiator circuit 30 in which coolant circulates between an inside and an outside of the engine 10, and a radiator 31 which cools the coolant is provided in a middle part of the radiator circuit 30. Moreover, provided in the radiator circuit 30 is a bypass flow passage 32 which is connected in parallel to the radiator 31 and causes coolant to bypass the radiator 31. The thermostat 33 is provided in a branched part at which the bypass flow passage 32 is branched from the radiator circuit 30. Depending on a temperature of coolant, the thermostat 33 adjusts a flow rate of coolant flowing through the radiator 31, and a flow rate of coolant flowing through the bypass flow passage 32. Coolant in the radiator circuit 30 is circulated by the water pump 34 in directions of arrows in FIG. 1.

Next, a structure of the EGR-gas cooling device 100 will be described referring to FIG. 2.

As shown in FIG. 2, the EGR-gas cooling device 100 includes an EGR gas cooler 100A and the thermostat 170A. Additionally, the EGR gas cooler 100A includes tubes 110, a casing 120, a coolant inlet portion 130, a first coolant outlet portion 140 and a second coolant outlet portion 150. Respective members forming the EGR gas cooler 100A are made of, for example, stainless material superior in heat resistance and in corrosion resistance, and the respective members are joined to one another by brazing of connection parts thereamong.

The tubes 110 of the EGR gas cooler 100A are pipe members forming exhaust gas passages through which EGR gas conveyed from the exhaust-gas recirculation pipe 13 flows. The tube 110 is formed in, for example, a rectangular flattened shape in its cross section perpendicular to a longitudinal direction of the tube 110. The tube 110 is formed by, for example, joining opening-side end portions of two U-shaped tube plates with each other which are formed in shallow U-shapes in cross section by press forming. The tubes 110 are stacked so that longitudinal surfaces (hereinafter, referred to as opposed surfaces) of the flattened cross-sections are opposed to each other.

Formed on both end portions of the opposed surfaces of the tube 110 in the longitudinal direction are convex portions. The convex portions extend along longitudinal sides of the flattened cross-section in both end portions of the tube 110 in the longitudinal direction. The stacked tubes 110 are joined such that the above-described convex portions contact each other, and clearances are provided between tubes 100 adjacent to each other in middle portions of the tubes 110 in the longitudinal direction.

Disposed inside the tube 110 is an inner fin. The inner fin is a heat transfer member which promotes heat exchange between EGR gas and coolant. Used as the inner fin is, for example, a corrugated fin formed in a rectangular corrugated shape in cross-section viewed in a flow direction of the EGR gas.

The casing 120 is provided so as to cover the stacked tubes 110, and is a hollow cylindrical member which extends in the longitudinal direction of the tubes 110 and has a rectangular shape in cross-section. The stacked tubes 110 are accommodated in a space portion inside the casing 120, and inner peripheral surfaces of both end portions of the casing 120 in the longitudinal direction and outer peripheral surfaces (regions on which the convex portions are formed) of both end portions of the stacked tubes 110 in the longitudinal direction are joined with each other. Thus, except for regions in which the casing 120 and tubes 110 are joined with each other, space is provided between an inner wall of the casing 120 and outer walls of the respective tubes 110 and between the respective tubes 110 adjacent to each other, and this space is a coolant passage 121. The coolant passage 121 corresponds to a cooling medium passage of the present invention. Coolant conveyed from the EGR coolant circuit 20 flows through the coolant passage 121.

Moreover, an open end portion of the tube 110 on its one end side in the longitudinal direction communicates with exteriors of the tube 110 and the casing 120 without communicating with the coolant passage 121. Formed on the one end side of the tube 110 in the longitudinal direction is an exhaust-gas inflow part 122 through which EGR gas flows into the tube 110. Similarly, an open end portion of the tube 110 on the other end side in the longitudinal direction communicates with exteriors of the tube 110 and the casing 120 without communicating with the coolant passage 121. Formed on the other side of the tube 110 in the longitudinal direction is an exhaust-gas outflow part 123 through which EGR gas flows out of the tube 110.

The coolant inlet portion 130 is an inflow portion through which coolant in the EGR coolant circuit 20 flows into the coolant passage 121, and is made of a pipe member. Formed on one side of the casing 121 in the longitudinal direction is a protruding portion 124 which protrudes perpendicularly to the longitudinal direction and outward. The coolant inlet portion 130 is connected to the protruding portion 124 so that the protruding direction of the protruding portion 124 and an axial direction of the coolant inlet portion 130 become coincident with each other. The coolant inlet portion 130 communicates with the coolant passage 121 in the casing 120 via the protruding portion 124.

The first coolant outlet portion 140 is a first outflow portion through which coolant in the coolant passage 121 flows out to an exterior, and is made of a pipe member. Formed on the other side of the casing 121 in the longitudinal direction is a protruding portion 125 which protrudes perpendicularly to the longitudinal direction and outward on an opposite side from the protruding portion 124. The first coolant outlet portion 140 is connected to the protruding portion 125 so that the protruding direction of the protruding portion 125 and an axial direction of the first coolant outlet portion 140 become coincident with each other. The first coolant outlet portion 140 is placed at a position diagonally opposite from the coolant inlet portion 130, and communicates with the coolant passage 121 in the casing 120 via the protruding portion 125.

A first outlet pipe 141 is connected to an end of the first coolant outlet portion 140. The first outlet pipe 141 is a flow passage on a downstream side of the first coolant outlet portion 140, and extends so as to be directed from the first coolant outlet portion 140 toward a center side of the casing 120 in its longitudinal direction: The first outlet pipe 141 may be a metallic pipe formed of stainless material similar to the tubes 110, the casing 120 and the first coolant outlet portion 140, or may be a rubber hose made of rubber material.

The second coolant outlet portion 150 is a second outflow portion through which coolant in the coolant passage 121 flows out to an exterior, and is made of a pipe member. Formed on the one side of the casing 121 in the longitudinal direction is a protruding portion 126 which protrudes perpendicularly to the longitudinal direction and outward on the opposite side from the protruding portion 124. The second coolant outlet portion 150 is connected to the protruding portion 126 so that the protruding direction of the protruding portion 126 and an axial direction of the second coolant outlet portion 150 become coincident with each other. The second coolant outlet portion 150 is placed at a position opposed to the coolant inlet portion 130, and communicates with the coolant passage 121 in the casing 120 via the protruding portion 126.

A second outlet pipe 151 is connected to an end of the second coolant outlet portion 150. The second outlet pipe 151 is a flow passage on a downstream side of the second coolant outlet portion 150, and extends so as to be directed from the second coolant outlet portion 150 toward the center side of the casing 120 in the longitudinal direction. The first outlet pipe 151 may be a metallic pipe formed of stainless material similar to the tubes 110, the casing 120 and the second coolant outlet portion 150, or may be a rubber hose made of rubber material.

An end portion of the first outlet pipe 141 and an end portion of the second outlet pipe 151 are connected to each other, and the first outlet pipe 141 and the second outlet pipe 151 are joined together so as to form a join portion 160. A region of the first outlet pipe 141 opening toward the join portion 160 is an opening 141a, and a region of the second outlet pipe 151 opening toward the join portion 160 is an opening 151a (see FIGS. 3 and 5).

The thermostat 170A is a flow-rate adjustment portion which adjusts a ratio between flow rates of coolant flowing out respectively of the first coolant outflow portion 140 and the second coolant outflow portion 150. The thermostat 170A is accommodated in the join portion 160, and includes a main body portion 171, a thermostatic portion 172, a first valve 173, a second valve 174, a piston 175 and a support portion 176.

The main body portion 171 is a base portion having a cylindrical shape, and its both end portions in an axial direction and its inside portion are connected to the above-described members. The main body portion 171 is placed on the first-outlet-pipe-141 side in the join portion 160, and is placed such that one side of the main body portion 171 in the axial direction is directed toward the first outlet pipe 141 and the other side of the main body portion 171 in the axial direction is directed toward the second outlet pipe 151.

The thermostatic portion 172 has a cylindrical shape, and is connected to the second-outlet-pipe-151 side of the main body portion 171 in the axial direction. Accommodated inside the thermostatic portion 172 is wax which expands or contracts depending on temperature of coolant flowing from the second coolant outlet portion 150 through the second outlet pipe 151.

The first valve 173 is a circular-plate-shaped valve element provided at the end portion of the main body portion 171 on the first-outlet-pipe-141 side in the axial direction, and opens or closes the opening 141a of the first outlet pipe 141 in the join portion 160. The first valve 173 is kept at a position where the opening 141a is fully closed when the EGR-gas cooling device 100 is under suspension or when a temperature of coolant on the second-coolant-outlet-151 side is lower than a predetermined temperature. Moreover, the first valve 173 has at least one of non-shown communication hole through which an interior of the first outlet pipe 141 communicates with an interior of the join portion 160. Thus, even when the first valve 173 is placed at the position where the opening 141a is fully closed in operation of the EGR-gas cooling device 100, coolant always flows from the first outlet pipe 141 (the first coolant outlet portion 140) to the join portion 160 at a certain flow rate.

The second valve 174 is a circular-plate-shaped valve element provided at an end portion of the thermostatic portion 172 on the second-outlet-pipe-151 side in the axial direction, and opens or closes the opening 151a of the second outlet pipe 151 in the join portion 160. The second valve 174 is urged toward the thermostatic portion 172 by a non-shown elastic body such as a spring, and is kept at a position (where the opening 151a is fully open) completely away from the opening 151a due to contraction of the wax in the thermostatic portion 172 when the EGR-gas cooling device 100 is under suspension or when a temperature of coolant on the second-coolant-outlet-151 side is lower than the predetermined temperature. Moreover, similar to the first valve 173, the second valve 174 has at least one of non-shown communication hole through which an interior of the second outlet pipe 151 communicates with the interior of the join portion 160. Thus, even when the second valve 174 is placed at the position where the opening 151a is fully closed in operation of the EGR-gas cooling device 100, coolant always flows from the second outlet pipe 151 (the second coolant outlet portion 150) to the join portion 160 at a certain flow rate.

The piston 175 is a thin and long pole-like member, and its one end side extends through the first valve 173 and protrudes into the first outlet pipe 141 while the other end side is accommodated in the main body portion 171 and the thermostatic portion 172. The one end side of the piston 175 is fixed to the support portion 176 provided inside the first outlet pipe 141. The other end side of the piston 175 is connected to the wax in the thermostatic portion 172. When a temperature of coolant on the second-outlet-pipe-151 side becomes higher than or equal to the predetermined temperature so that the wax expands, the other end side of the piston 175 is pressed from the thermostatic portion 172 toward the main body portion 171. At this time, since the one end side of the piston 175 is fixed to the support portion 176, the expansion of the wax causes the main body portion 171 and the thermostatic portion 172 to move toward the second outlet pipe 151. Additionally, the first valve 173 moves to open the opening 141a, and the second valve 174 moves to close the opening 51 a against the urging force of the non-shown elastic body.

Next, operations and effects of the EGR-gas cooling device 100 based on the above-described structure will be described in reference to FIGS. 3 to 6.

In regard to the EGR-gas cooling device 100 of the present embodiment, when the EGR valve 14 is open, a part of exhaust gas in the exhaust gas pipe 12 passes through the exhaust-gas recirculation pipe 13 as EGR gas, and flows into the multiple tubes 110 through the exhaust-gas inflow part 122. The EGR gas which has passed through the multiple tubes 110 flows out through the exhaust-gas outflow part 123, and is supplied to the intake air pipe 11 of the engine 10 through the EGR valve 14.

On the other hand, coolant of the engine 10 flows into the casing 120 through the coolant inlet portion 130. The coolant which has flowed into the casing 120 flows so as to form two following main streams as shown in FIG. 2. That is, the first stream passes mainly through the coolant passage 121 in its longitudinal direction, and leads to the first coolant outlet portion 140 located to be diagonally opposite from the coolant inlet portion 130 and further to the join portion 160 through the first outlet pipe 141. The second stream is perpendicular mainly to the longitudinal direction of the coolant passage 121, and leads to the second coolant outlet portion 150 located to be opposed to the coolant inlet portion 130, and further to the join portion 160 through the second outlet pipe 151. The coolant joined together in the join portion 160 flows to the radiator circuit 30.

In addition, heat exchange is performed between the EGR gas flowing through interiors of the multiple tubes 110 and the coolant flowing through the coolant passage 121, and thus the EGR gas is cooled. Since the EGR gas cooled as described above is supplied to the intake air pipe 11 of the engine 10, a highest temperature of combustion in the engine 10 is reduced, and a production amount of nitrogen oxide is decreased.

In the present embodiment, the thermostat 170A is provided in the join portion 160, and this thermostat 170A adjusts the ratio between flow rates of coolant flowing out through the first coolant outlet portion 140 (the first outlet pipe 141) and through the second coolant outlet portion 150 (the second outlet pipe 151).

More specifically, depending on the operating condition of the engine 10, when a heat amount of the EGR gas is larger than a predetermined heat amount, the thermostat 170A sets a flow rate of coolant flowing out through the first coolant outlet portion 140 larger than a flow rate of coolant flowing out through the second coolant outlet portion 150. When the heat amount of the EGR gas is lower than the predetermined heat amount, the thermostat 170A sets the flow rate of coolant flowing out through the second coolant outlet portion 150 larger than the flow rate of coolant flowing out through the first coolant outlet portion 140.

The time when the heat amount of the EGR gas is larger than the predetermined heat amount is when load of the engine 10 is high, for example, in high-speed running or climbing running, i.e., when the EGR-gas cooling device 100 is required to cool a more amount of the EGR gas. In contrast, the time when the heat amount of the EGR gas is lower than the predetermined heat amount is when load of the engine 10 is low, for example, in low-speed running or idling, i.e., when cooling of the EGR-gas is not required so much.

The larger the heat amount of the EGR gas is, the larger a heat exchange amount between the EGR gas and the coolant in the EGR gas cooler 100A is, and the higher the temperature of the coolant is. Conversely, the smaller the heat amount of the EGR gas is, the smaller the heat exchange amount between the EGR gas and the coolant in the EGR gas cooler 100A is, and the lower the temperature of the coolant is. Accordingly, the heat amount of the EGR gas and the temperature of the coolant are related to each other. The thermostat 170A increases an excess flow rate of coolant flowing out through the first coolant outlet portion 140 over the flow rate of coolant flowing out through the second coolant outlet portion 150 in accordance with increase of the temperature of the coolant. On the other hand, the thermostat 170A increases an excess flow rate of coolant flowing out through the second coolant outlet portion 150 over the flow rate of coolant flowing out through the first coolant outlet portion 140 in accordance with decrease of the temperature of the coolant. In this case, used as the temperature of the coolant is a temperature of coolant flowing out through the second coolant outlet portion 150.

More specifically, in the thermostat 170A, the wax in the thermostatic portion 172 expands or contracts depending on the temperature of the coolant flowing out through the second coolant outlet portion 150. As shown in FIG. 3, when the temperature of the coolant is lower than a predetermined temperature, the wax stays in contraction, and the second valve 174 is urged toward the thermostatic portion 172 by non-shown elastic body and is kept at the position where the opening 151a is fully open. At the same time, the first valve 173 is kept at the position where the opening 141a is fully closed. Hence, as shown in FIG. 4, coolant inflowing through the coolant inlet portion 130 reaches the join portion 160 mainly through the second coolant outlet portion 150, the second outlet pipe 151 and the opening 151a. The coolant flows at a low flow rate through the coolant passage 121 in the longitudinal direction and reaches the join portion 160 through the first coolant outlet portion 140, the first outlet pipe 141 and the non-shown communication hole of the first valve 173.

Accordingly, when the temperature of the coolant is lower than the predetermined temperature, the thermostat 170A is capable of reducing the flow rate of coolant flowing from the coolant inlet portion 130 to the first coolant outlet portion 140 through the coolant passage 121, and thus capable of limiting the heat exchange between the EGR gas and the coolant and preventing supercooling of the EGR gas. Moreover, since the flow rate of coolant flowing from the coolant inlet portion 130 directly to the second coolant outlet portion 150 can be increased, generation of a dead flow zone can be prevented, and thus local boiling of the cooling medium can be prevented.

Next, as shown in FIG. 5, when the temperature of the coolant is higher than the predetermined temperature, the wax in the thermostatic portion 172 expands, and the second valve 174 is moved toward the opening 151a against the urging force of the non-shown elastic body so as to close the opening 151a. In other words, the second valve 174 reduces an opening degree of the opening 151a in accordance with increase of the temperature of the coolant. At the same time, the first valve 173 moves with the second valve 174 to open the opening 141a. In other words, the first valve 173 increases an opening degree of the opening 141a in accordance with increase of the temperature of the coolant. Hence, as shown in FIG. 6, coolant inflowing through the coolant inlet portion 130 flows mainly through the coolant passage 121 in the longitudinal direction, and reaches the join portion 160 through the first coolant outlet portion 140, the first outlet pipe 141 and the opening 141a. The coolant reaches the join portion 160 at a low flow rate through the second coolant outlet portion 150, the second outlet pipe 151 and the non-shown communication hole of the second valve 174.

Accordingly, when the temperature of the coolant is higher than the predetermined temperature, the thermostat 170A is capable of adjusting so that the flow rate of coolant flowing out through the first coolant outlet portion 140 becomes higher than the flow rate of coolant flowing out through the second coolant outlet portion 150 in the coolant passage 121. Thus, since the flow rate of the coolant flowing from the coolant inlet portion 130 to the first coolant outlet portion 140 through the coolant passage 121 can be increased depending on the temperature of the coolant, the heat exchange between the EGR gas and the coolant can be performed surely, and a temperature of the EGR gas can be reduced appropriately.

Moreover, the thermostat 170A generally allows coolant to flow out through the first coolant outlet portion 140 and the second coolant outlet portion 150 through the non-shown communication holes provided in the respective valves 173 and 174. Because coolant flows mainly out through the first coolant outlet portion 140 while a part of the coolant flows out through the second coolant outlet portion 150, the local boiling of the cooling medium can be prevented surely. Because coolant flows mainly out through the second coolant outlet portion 150 while a part of the coolant flows out through the first coolant outlet portion 140, a basic capacity to cool the EGR gas with the coolant can be ensured.

The thermostat 170A adjusts an open degree of each valve 173, 174 depending on the temperature of the coolant flowing out through the second coolant outlet portion 150. Coolant which has exchanged heat with the EGR gas in the coolant passage 121 flows out through the second coolant outlet portion 150 earlier than flowing out through the first coolant outlet portion 140. Since the open degree of each valve 173, 174 is adjusted depending on the temperature of the coolant flowing through the second coolant outlet portion 150, the flow rate adjustment with high responsiveness is possible.

Since the thermostat 170A adjusts the ratio between the flow rates of coolant flowing out through the first coolant outlet portion 140 and of the second coolant outlet portion 150, a total flow rate of coolant flowing from the coolant inlet portion 130 through the coolant passage 121 is not changed, and thus other flow systems, i.e., the radiator circuit 30 and the like is not affected negatively.

### Second Embodiment

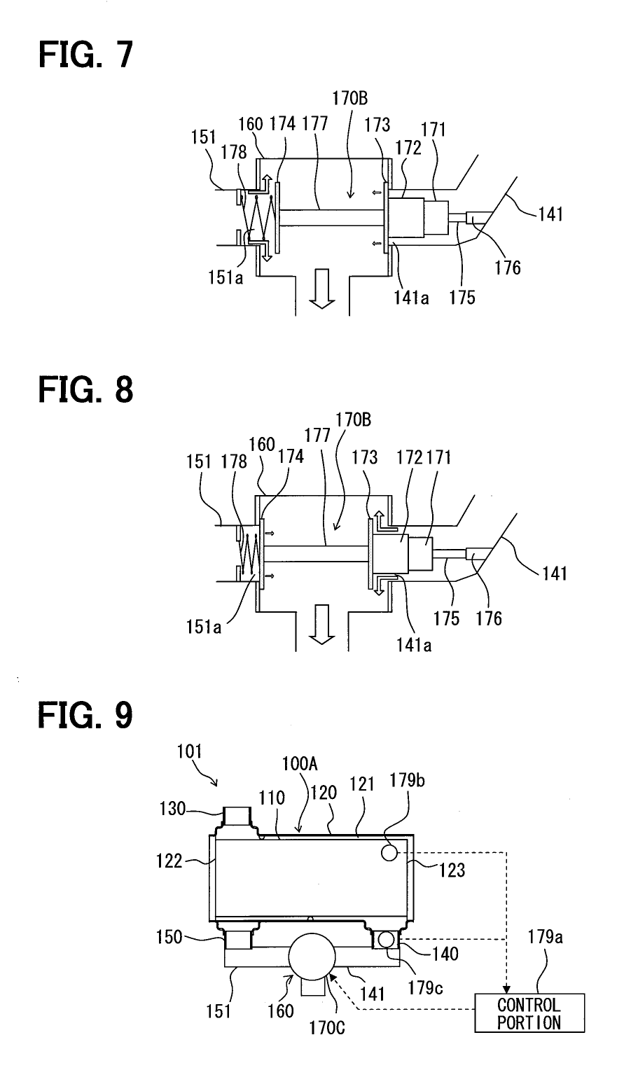

FIGS. 7 and 8 show a flow-rate adjustment portion according to a second embodiment, i.e., a thermostat 170B. In the thermostat 170B of the second embodiment, a first valve 173 and a second valve 174 operate depending on a temperature of coolant flowing out through a first coolant outlet portion 140, in contrast to the thermostat 170A of the above-described first embodiment.

A main body portion 171 and a thermostatic portion 172 of the thermostat 170B are disposed in the first outlet pipe 141 in whole or in part. The first valve 173 is provided on an opposite side of the thermostatic portion 172 from the main body portion 171, and opens or closes an opening 141a of the first outlet pipe 141 in a join portion 160. The first valve 173 is kept at a position where the opening 141a is fully closed when the EGR-gas cooling device 100 is under suspension or when the temperature of the coolant on the first-outlet-pipe-141 side is lower than a predetermined temperature. Moreover, the first valve 173 has at least one non-shown communication hole through which an interior of the first outlet pipe 141 communicates with an interior of the join portion 160. Even when the first valve 173 is placed at the position where the opening 141a is fully closed in operation of the EGR-gas cooling device 100, coolant generally flows from the first outlet pipe 141 (the first coolant outlet portion 140) to the join portion 160 at a certain flow rate.

The second valve 174 is connected to the first valve 173 via a rod-like connection portion 177, and opens or closes an opening 151a of a second outlet pipe 151 in the join portion 160. The second valve 174 is urged from the opening 151a toward the first valve 173 by an elastic body 178 such as a spring. When the EGR-gas cooling device 100 is under suspension, or when the temperature of the coolant on the first-outlet-pipe-141 side is lower than the predetermined temperature, wax in the thermostatic portion 172 stays in contraction. Hence, the second valve 174 is kept at a position (where the opening 151a is fully open) completely away from the opening 151a. Moreover, similar to the first valve 173, the second valve 174 has at least one non-shown communication hole through which an interior of the second outlet pipe 151 communicates with the interior of the join portion 160. Even when the second valve 174 is placed at the position where the opening 151a is fully closed in operation of the EGR-gas cooling device, coolant generally flows from the second outlet pipe 151 (the second coolant outlet portion 150) to the join portion 160 at a certain flow rate.

In the thermostat 170B, the wax in the thermostatic portion 172 expands or contracts depending on the temperature of the coolant flowing out through the first coolant outlet portion 140. As shown in FIG. 7, when the temperature of the coolant is lower than the predetermined temperature, the wax stays in contraction, and the second valve 174 is urged toward the thermostatic portion 172 by the elastic body 178 and kept at the position where the opening 151a is fully open. At the same time, the first valve 173 is kept at the position where the opening 141a is fully closed. Thus, coolant inflowing through the coolant inlet portion 130 reaches the join portion 160 mainly through the second coolant outlet portion 150, the second outlet pipe 151 and the opening 151a. The coolant flows at a low flow rate through the coolant passage 121 in the longitudinal direction and reaches the join portion 160 through the first coolant outlet portion 140, the first outlet pipe 141 and the non-shown communication hole of the first valve 173.

Moreover, as shown in FIG. 8, when the temperature of the coolant is higher than the predetermined temperature, the wax expands, and the second valve 174 moves toward the opening 151a against urging force of the elastic body 178 so as to close the opening 151a. In other words, the second valve 174 reduces a valve open degree corresponding to the opening 151a in accordance with temperature increase of the coolant. At the same time, the first valve 173 moves with the second valve 174 so as to open the opening 141a. In other words, the first valve 173 increases a valve open degree corresponding to the opening 141a in accordance with the temperature increase of the coolant. Thus, coolant inflowing through the coolant inlet portion 130 flows mainly through the coolant passage 121 in the longitudinal direction and reaches the join portion 160 through the first coolant outlet portion 140, the first outlet pipe 141 and the opening 141a. The coolant reaches the join portion 160 at a low flow rate through the second coolant outlet portion 150, the second outlet pipe 151 and the non-shown communication hole of the second valve 174.

Accordingly, an open-close operation of each valve 173, 174 depending on the temperature of the coolant is same as that of the above-described first embodiment, and similar effects to the first embodiment can be obtained in the second embodiment. Since coolant which has exchanged heat with EGR gas in the coolant passage 121 flows out through the first coolant outlet portion 140 later than flowing out through the second coolant outlet portion 150, responsiveness of the valve-open-degree adjustment depending on the temperature of coolant is a little worse than the first embodiment.

### Third Embodiment

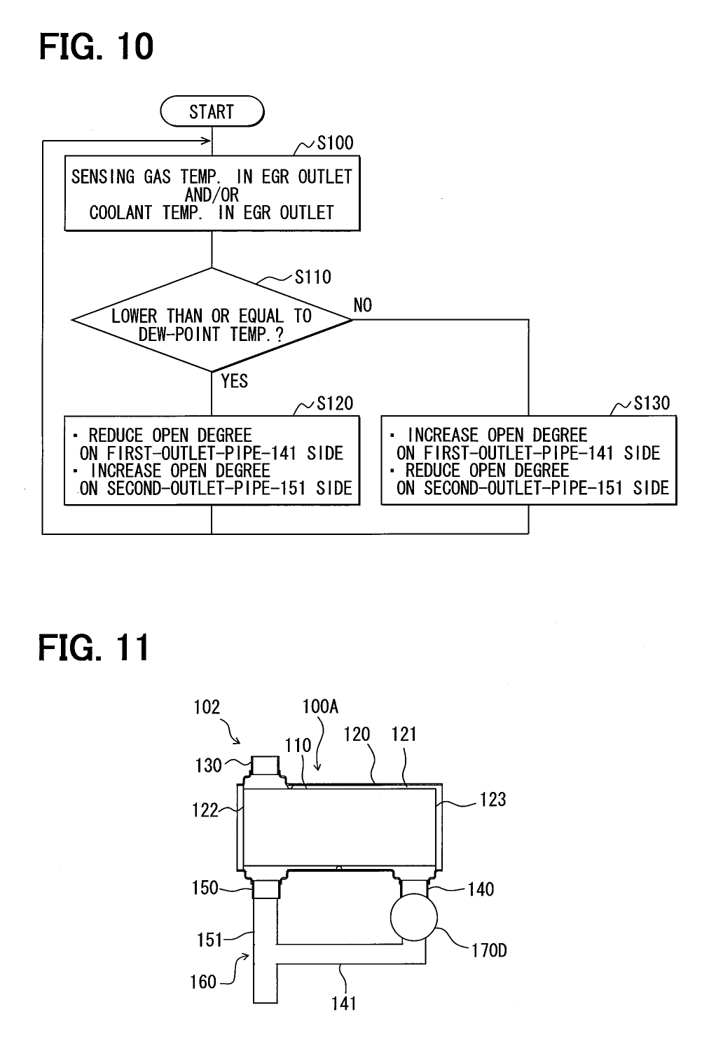

FIGS. 9 and 10 show an EGR-gas cooling device 101 and a flowchart for control of an electromagnetic valve 170C according to a third embodiment. In the EGR-gas cooling device 101 of the third embodiment, the thermostat 170A is changed to the electromagnetic valve 170C, and a control portion 179a, an exhaust-gas temperature sensor 179b and a temperature sensor 179c are provided, in contrast to the EGR-gas cooling device 100 of the above-described first embodiment.

The electromagnetic valve 170C is an electric valve which adjusts open degrees of an opening 141a of a first outlet pipe 141 and an opening 151a of a second outlet pipe 151 in a join portion 160 in accordance with an electric signal from an external, i.e., from the control portion 179a. The electromagnetic valve 170C adjusts the open degree of the opening 141a from approximately 0% to 100% while adjusting the open degree of the opening 151a from 100% to approximately 0%. In other words, the electromagnetic valve 170C adjusts the respective open degrees so as to increase the open degree of one opening 141a (151a) while decreasing the open degree of the other opening 151a (141a). The above-describe approximately 0% of the open degree means that the electromagnetic valve 170C generally allows the coolant to flow at a certain flow rate through the openings 141a, 151a without fully closing the openings 141a, 151a, similarly to the above-described first and second embodiments.

The exhaust-gas temperature sensor 179b is an exhaust-gas temperature detection portion which detects a temperature of EGR gas cooled by coolant, and is provided on, for example, a downstream side in an EGR-gas flow in a tube 110 of an EGR cooler 100A (near an exhaust-gas outflow part 123). A temperature signal of the EGR gas detected by the exhaust-gas temperature sensor 179b is to be outputted to the control portion 179a.

The coolant temperature sensor 179c is a coolant temperature detection portion detecting a temperature of coolant which flows though a coolant passage 121 in a longitudinal direction and is increased in temperature by EGR gas. The coolant temperature sensor 179c is provided in, for example, a first coolant outlet portion 140 of the EGR cooler 100A. A temperature signal of the coolant detected by the coolant temperature sensor 179c is to be outputted to the control portion 179a.

In the present embodiment, both the exhaust-gas temperature sensor 179b and the coolant temperature sensor 179c are provided, but only either one may be provided. At step S100 of the flowchart in FIG. 10 described below, it is described that a temperature signal is read under an “And” condition or an “Or” condition in regard to the EGR gas temperature and the coolant temperature. The “And” condition or the “Or” condition may be selected depending on a setting of each temperature sensor. Since the lower one between the EGR gas temperature and the coolant temperature is the coolant temperature naturally, a dew condensation determination may be performed by using the coolant temperature at following step S110. Accordingly, a safe-side determination regarding dew condensation can be obtained (a dew condensation state of EGE gas can be determined surely).

Hereinafter, in reference to the control flow shown in FIG. 10, a manner of an open degree control of the electromagnetic valve 170C by the control portion 179a will be described. Firstly, at step S100, the control portion 179a read an EGR-gas temperature signal obtained by the exhaust-gas temperature sensor 179b and a coolant temperature signal obtained by the coolant temperature sensor 179c (when either one of the temperature sensors is provided, the EGR-gas temperature signal or the coolant temperature signal is read).

Next, at step S110, the control portion 179a determines whether the temperature signal read at step S100 is lower than or equal to a dew-point temperature of the EGR gas or not. When the read temperature signal is lower than or equal to the dew-point temperature of the EGR gas, a temperature of the EGR gas is low, and this case corresponds to when a heat amount of the EGR gas is lower than a predetermined heat amount. Conversely, when the read temperature signal is higher than the dew-point temperature of the EGR gas, the temperature of the EGR gas is high, and this case corresponds to when the heat amount of the EGR gas is higher than the predetermined heat amount.

When determined positively at step S110, the control portion 179a, at step S120, reduces the open degree of the opening 141a of the first outlet pipe 141 in the join portion 160 so as to provide a closed side valve while increasing the open degree of the opening 151a of the second outlet pipe 151 in the join portion 160 so as to provide an open side valve. Accordingly, coolant inflowing through the coolant inlet portion 130 reaches the join portion 160 mainly through a second coolant outlet portion 150, the second outlet pipe 151 and the opening 151a. The coolant flows at a low flow rate through the coolant passage 121 in the longitudinal direction, and reaches the join portion 160 through the first coolant outlet portion 140, the first outlet pipe 141 and the opening 141a.

Since heat exchange between the EGR gas and the coolant in the EGR gas cooler 100A can be limited, the EGR gas temperature and the coolant temperature are controlled to approach the dew-point temperature of the EGR gas or to be higher than or equal to the dew-point temperature of the EGR gas, and condensation of the EGR gas due to supercooling thereof can be restricted.

When determined negatively at step S110, the control portion 179a, at step S130, increases the open the open degree of the opening 141a of the first outlet pipe 141 in the join portion 160 so as to provide the open side valve while reducing the open degree of the opening 151a of the second outlet pipe 151 in the join portion 160 so as to provide the closed side valve. Accordingly, coolant inflowing through the coolant inlet portion 130 flows mainly through the coolant passage 121 in the longitudinal direction, and reaches the join portion 160 through the first coolant outlet portion 140, the first outlet pipe 141 and the opening 141a. The coolant reaches the join portion 160 at a low flow rate through the second coolant outlet portion 150, the second outlet pipe 151 and the opening 151a.

Since the EGR gas is cooled surely by using the coolant, the temperature of the EGR gas can be reduced appropriately.

### Fourth Embodiment

FIG. 11 shows an EGR-gas cooling device 102 according to a fourth embodiment. In the EGR-gas cooling device 102 of the fourth embodiment, a thermostat 170D as a flow-rate adjustment portion is provided along a first outlet pipe 141, in contrast to the EGR-gas cooling device 100 of the above-described first embodiment.

In the thermostat 170D, a valve is provided so as to open or close a flow passage of the first outlet pipe 141 depending on a temperature of coolant, and the passage of the first outlet pipe 141 is opened or closed from approximately 0% to 100%. The above-describe approximately 0% means that the thermostat 170D generally allows coolant to flow at a certain flow rate through the first outlet pipe 141 (a first coolant outlet portion 140) without fully closing the passage of the first outlet pipe 141, similarly to the above-described first to third embodiments.

The thermostat 170D operates toward closing of the passage of the first outlet pipe 141 when a temperature of coolant is lower than a predetermined temperature (when a heat amount of EGR gas is smaller than a predetermined heat amount). On the contrary, the thermostat 170D operates toward opening of the passage of the first outlet pipe 141 when the temperature of coolant is higher than the predetermined temperature (when the heat amount of EGR gas is larger than the predetermined heat amount).

When the temperature of coolant is lower than the predetermined temperature, the thermostat 170D closes the valve so that coolant flows in the first outlet pipe 141 at a certain flow rate. Thus, coolant inflowing through a coolant inlet portion 130 reaches a join portion 160 mainly through a second coolant outlet portion 150 and a second outlet pipe 151. Coolant flows at a low flow rate through a coolant passage 121 in a longitudinal direction, and reaches the join portion 160 through the first coolant outlet portion 140, the first outlet pipe 141 and the thermostat 170D.

When the temperature of coolant is higher than the predetermined temperature, the thermostat 170D increases an open degree of the valve in the first outlet pipe 141. Thus, coolant inflowing through the coolant inlet portion 130 reaches the join portion 160 through the second coolant outlet portion 150 and the second outlet pipe 151 while flowing through the coolant passage 121 in the longitudinal direction to reach the join portion 160 through the first coolant outlet portion 140, the first outlet pipe 141 and the thermostat 170D.

Accordingly, the thermostat 170D is capable of adjusting a flow rate of the coolant flowing out through the first coolant outlet portion 140 or the second coolant outlet portion 150 depending on the temperature of coolant in the present embodiment. Thus, effects similar to the above-described first to third embodiments can be obtained. Coolant which has exchanged heat with EGR gas in the coolant passage 121 flows out through the first coolant outlet portion 140 later than flowing out through the second coolant outlet portion 150. Hence, responsiveness of valve-open-degree adjustment dependent on the temperature of coolant is similar to that of the second embodiment.

### Fifth Embodiment

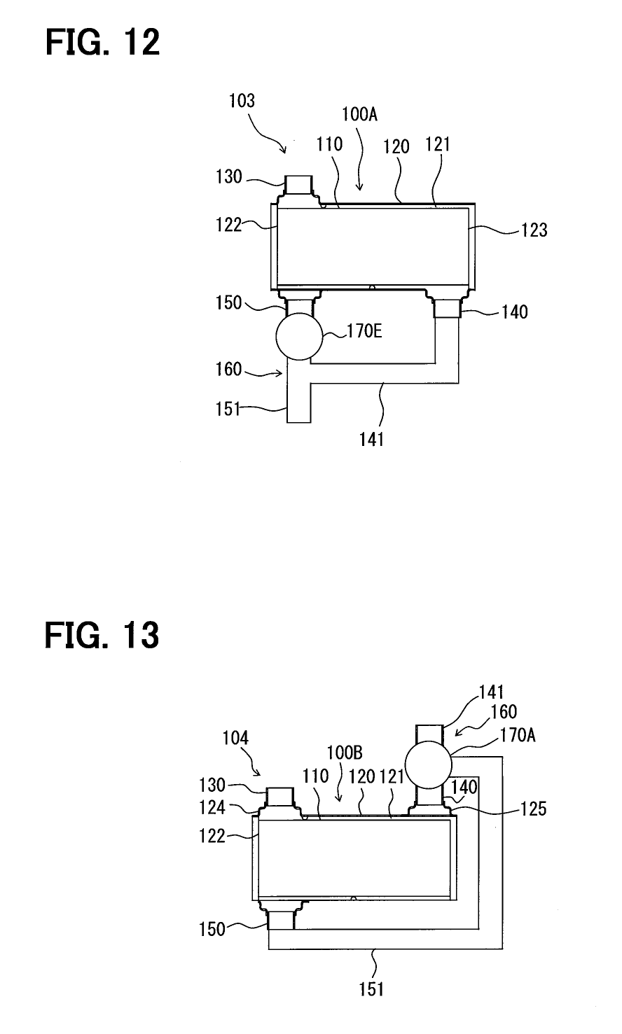

FIG. 12 shows an EGR-gas cooling device 103 according to a fifth embodiment. In the EGR-gas cooling device 103 of the fifth embodiment, a thermostat 170E as a flow-rate adjustment portion is provided along a second outlet pipe 151, in contrast to the EGR-gas cooling device 100 of the above-described first embodiment.

In the thermostat 170E, a valve is provided so as to open or close a flow passage of the second outlet pipe 151 depending on a temperature of coolant, and the passage of the second outlet pipe 151 is opened or closed from approximately 0% to 100%. The above-describe approximately 0% means that the thermostat 170E generally allows coolant to flow at a certain flow rate through the second outlet pipe 151 (a second coolant outlet portion 150) without fully closing the passage of the second outlet pipe 151, similarly to the above-described first to fourth embodiments.

The thermostat 170E operates toward opening of the passage of the second outlet pipe 151 when a temperature of coolant is lower than a predetermined temperature (when a heat amount of EGR gas is smaller than a predetermined heat amount). On the contrary, the thermostat 170E operates toward closing of the passage of the second outlet pipe 151 when the temperature of coolant is higher than the predetermined temperature (when the heat amount of EGR gas is larger than the predetermined heat amount).

When the temperature of coolant is lower than the predetermined temperature, the thermostat 170E opens the valve so that the coolant flows in the second outlet pipe 151. Thus, coolant inflowing through a coolant inlet portion 130 reaches a join portion 160 mainly through the second coolant outlet portion 150, the second outlet pipe 151 and the thermostat 170E. The coolant flows at a low flow rate through a coolant passage 121 in a longitudinal direction, and reaches the join portion 160 through a first coolant outlet portion 140 and a first outlet pipe 141.

When the temperature of coolant is higher than the predetermined temperature, the thermostat 170E reduces an open degree of the valve in the second outlet pipe 151. Thus, a part of coolant inflowing through the coolant inlet portion 130 reaches the join portion 160 through the second coolant outlet portion 150, the second outlet pipe 151 and the thermostat 170E while most of the coolant flows through the coolant passage 121 in the longitudinal direction to reach the join portion 160 through the first coolant outlet portion 140 and the first outlet pipe 141.

Accordingly, the thermostat 170E is capable of adjusting the flow rate of coolant flowing out through the first coolant outlet portion 140 or the second coolant outlet portion 150 depending on the temperature of coolant in the present embodiment. Thus, effects similar to the above-described first to fourth embodiments can be obtained.

### Sixth Embodiment

FIG. 13 shows an EGR-gas cooling device 104 according to a sixth embodiment. In the EGR-gas cooling device 104 of the sixth embodiment, a setting position of a first coolant outlet portion 140 within an EGR gas cooler 100B is changed, in contrast to the EGR-gas cooling device 100 of the above-described first embodiment.

Formed on the other side of a casing 120 in its longitudinal direction is a protruding portion 125 which protrudes perpendicularly to the longitudinal direction and outward on the same side as a protruding portion 124. The first coolant outlet portion 140 is connected to the protruding portion 125 so that the protruding direction of the protruding portion 125 and an axial direction of the first coolant outlet portion 140 become coincident with each other. Connected to an end of the first coolant outlet portion 140 is a first outlet pipe 141.

On the other hand, an end portion of a second outlet pipe 151 is connected and joined to the first outlet pipe 141, and thus a join portion 160 is formed. A thermostat 170A similar to that of the first embodiment is provided in the join portion 160. The thermostat 170A adjusts an open degree on the first-outlet-pipe-141 side or an open degree on the second-outlet-pipe-151 side depending on a temperature of coolant flowing through the second outlet pipe 151, similar to the first embodiment.

Also in the case where the first coolant outlet portion 140 is configured to be directed in the same direction as a coolant inlet portion 130 in the casing 120 of the EGR gas cooler 100B, the thermostat 170A is capable of adjusting the flow rate of coolant flowing out through the first coolant outlet portion 140 or a second coolant outlet portion 150 depending on the temperature of the coolant. Thus, effects similar to the above-described first to fifth embodiments can be obtained.

### Other Embodiments

In the above-described embodiments, in the EGR gas cooler 100A, 100B, the convex portions are formed at the opposed surfaces in both end portions of the tubes 110 in the longitudinal direction, and the above-described convex portions are joined to be in contact with each other when the multiple tubes 110 are stacked. Additionally, the inner peripheral surfaces of both end portions of the casing 120 in the longitudinal direction and outer peripheral surfaces (regions on which the convex portions are formed) of both end portions of the stacked tubes 110 in the longitudinal direction are joined with each other. However, not only this, a so-called shell-and-tube EGR gas cooler may be used, in which both end portions of multiple tubes 110 penetrate through a plate member to be joined thereto, and an outer periphery of the plate member is joined to an inner peripheral surface of a casing 120.

Moreover, the objective engine in EGR (exhaust-gas recirculation device) is described as the diesel engine, but may be as a gasoline engine.

The coolant of the engine 10 is used as the cooling medium of the EGR gas cooler 100A, 1006, but not limiting to this, coolant of a special coolant circuit formed independently from the engine 10 may be used. The special coolant circuit may be a circuit including a sub radiator and a special pump.

The present invention is disclosed in reference to the preferable embodiments, but the present invention can be understood not to be limited to the preferable embodiments or their structures. The present invention is designed to include various modifications and equivalent arrangements. Additionally, a preferable embodiment including or omitting just a single element, or a combination of other various embodiments is also within the scope and target of the invention.

1. An exhaust-gas heat exchange device comprising:
an exhaust gas passage through which exhaust gas discharged from an internal combustion engine flows;
a casing provided to cover the exhaust gas passage, the casing having a cooling medium passage through which a cooling medium flows between an inner wall of the casing and an outer wall of the exhaust gas passage;
an inflow portion through which the cooling medium flows into the cooling medium passage, the inflow portion being provided on one end side of the casing that extends along the exhaust gas passage;
a first outflow portion through which the cooling medium flows out of the cooling medium passage, the first outflow portion being provided on the other end side of the casing that extends along the exhaust gas passage;
a second outflow portion through which the cooling medium flows out of the cooling medium passage, the second outflow portion being provided on the one end side of the casing that extends along the exhaust gas passage and at a position opposed to the inflow portion, a downstream side of the second outflow portion joining a downstream side of the first outflow portion; and
a flow-rate adjustment portion which generally allows the cooling medium to flow out through the first outflow portion and the second outflow portion, and adjusts a ratio between flow rates of the cooling medium flowing out through the first outflow portion and the second outflow portion.

2. The exhaust-gas heat exchange device according to claim 1, wherein
the flow-rate adjustment portion sets the flow rate of the cooling medium flowing out through the first outflow portion higher than the flow rate of the cooling medium flowing out through the second outflow portion depending on an operating condition of the internal combustion engine when a heat amount of the exhaust gas is larger than a predetermined heat amount, and
the flow-rate adjustment portion sets the flow rate of the cooling medium flowing out through the second outflow portion higher than the flow rate of the cooling medium flowing out through the first outflow portion when the heat amount of the exhaust gas is smaller than the predetermined heat amount.

3. The exhaust-gas heat exchange device according to claim 2, wherein the flow-rate adjustment portion is a thermostat, which adjusts an open degree of a valve element that is provided on at least one of the downstream side of the first outflow portion or the downstream side of the second outflow portion, depending on a temperature of the cooling medium, wherein the temperature of the cooling medium changes based on the heat amount of the exhaust gas.

4. The exhaust-gas heat exchange device according to claim 3, wherein the thermostat adjusts the open degree of the valve element depending on a temperature of the cooling medium flowing through the second outflow portion.

5. The exhaust-gas heat exchange device according to claim 2, wherein the flow-rate adjustment portion is an electric valve which opens or closes at least one of the first outflow portion or the second outflow portion by an external electric signal corresponding to at least one of a temperature of the cooling medium or a temperature of the exhaust gas that changes depending on the heat amount of the exhaust gas.
